(19) United States
(12) Patent Application Publication
(10) Pub. No.: US 2026/0148704 A1
(43) Pub. Date: May 28, 2026

(54) PROCESSING CIRCUIT OF DISPLAY AND ASSOCIATED CONTROL METHOD

(71) Applicant: Realtek Semiconductor Corp., HsinChu (TW)

(72) Inventors: Te-Yu Lin, HsinChu (TW); Fang-Hsiung Chen, HsinChu (TW)

(73) Assignee: Realtek Semiconductor Corp., HsinChu (TW)

(21) Appl. No.: 19/302,103

(22) Filed: Aug. 18, 2025

(30) Foreign Application Priority Data
Nov. 27, 2024 (TW) 113145755

(51) Int. Cl. G09G 3/34

(52) U.S. Cl. CPC G09G 3/3406; G09G 2320/0653; G09G 2320/066; G09G 2320/0686; G09G 2360/144

(57) ABSTRACT

The present invention provides a processing circuit of a display, which includes a statistical circuit, a backlight brightness calculation circuit and a local dimming control circuit. The statistical circuit is configured to calculate brightness characteristic of each region of multiple regions in image data. The backlight brightness calculation circuit is configured to determine backlight brightness of each region according to ambient light brightness of the display and the brightness characteristics of each region. The local dimming control circuit is coupled to the backlight brightness calculation circuit, and is configured to generate a corresponding backlight control signal according to the backlight brightness of each region to control at least one backlight source in a display panel of the display corresponding to the region.

### BACKGROUND OF THE INVENTION

### 1. FIELD OF THE INVENTION

The present invention relates to a control method of a display.

### 2. DESCRIPTION OF THE PRIOR ART

With the widespread adoption of electronic devices and changes in work and leisure habits, the amount of time users spend viewing displays has significantly increased, and prolonged viewing of displays has many adverse effects on eye health. As a result, many new technologies have been proposed in recent years in the field of eye care to address issues such as eye strain, comfort, and more. For example, some displays are equipped with intelligent dimming functions, which adjust the brightness to higher levels in brighter environments and lower levels in darker environments to improve user comfort when viewing display content.

However, the aforementioned intelligent dimming function does not take into account the content of the images displayed on the screen. Therefore, when the display is in a very dark environment and the overall screen brightness is reduced, if the displayed content itself corresponds to very low brightness (e.g., images of nighttime scenes or in a dark room), it can result in the loss of image details or blurring, thereby affecting the quality of the viewing experience.

### SUMMARY OF THE INVENTION

It is therefore an objective of the present invention to provide a control method of a display, which can dynamically adjust the brightness of the display in each area according to the ambient light brightness and the brightness of the image content, to solve the above-mentioned problems.

According to one embodiment of the present invention, a processing circuit of a display comprises a statistical circuit, a backlight brightness calculation circuit and a local dimming control circuit. The statistical circuit is configured to calculate brightness characteristic of each region of multiple regions in image data. The backlight brightness calculation circuit is configured to determine backlight brightness of each region according to ambient light brightness of the display and the brightness characteristics of each region. The local dimming control circuit is coupled to the backlight brightness calculation circuit, and is configured to generate a corresponding backlight control signal according to the backlight brightness of each region to control at least one backlight source in a display panel of the display corresponding to the region.

According to one embodiment of the present invention, a control method of a display comprises the steps of: calculating brightness characteristic of each region of multiple regions in image data; determining backlight brightness of each region according to ambient light brightness of the display and the brightness characteristics of each region; and generating a corresponding backlight control signal according to the backlight brightness of each region to control at least one backlight source in a display panel of the display corresponding to the region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display according to an embodiment of the present invention.

FIG. 2 is a schematic diagram of multiple regions of image data.

FIG. 3 shows the relationship between ambient light brightness and the maximum backlight brightness of each region of the display according to an embodiment of the present invention.

FIG. 4 is a schematic diagram of the backlight brightness of different regions of the display in bright and dark environments.

FIG. 5 is a flowchart of a control method of a display according to an embodiment of the present invention.

### DETAILED DESCRIPTION

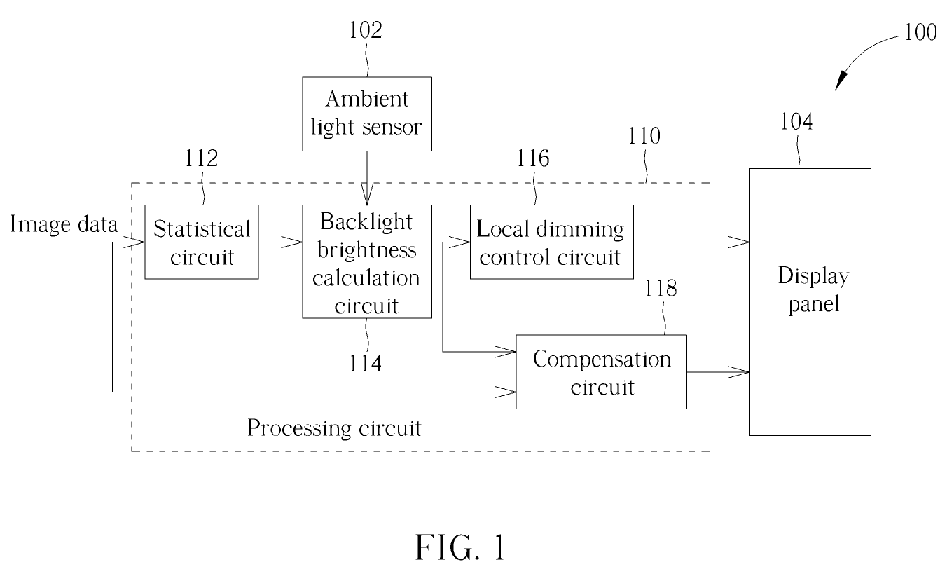

FIG. 1 is a schematic diagram of a display 100 according to an embodiment of the present invention. As shown in FIG. 1, the display 100 includes a processing circuit 110, an ambient light sensor 102, and a display panel 104. The processing circuit 110 comprises a statistical circuit 112, a backlight brightness calculation circuit 114, a local dimming control circuit 116, and a compensation circuit 118. The processing circuit 110 is configured to receive image data and generate a backlight control signal to adjust the brightness of the display panel 104, and also processes the image data to generate processed image data, which is then displayed on the display panel 104. In this embodiment, the display 100 can be of any type of a display, or the display 100 is integrated into an electronic device having a display/display panel, such as a television, laptop, desktop monitor, tablet, smartphone, and so on.

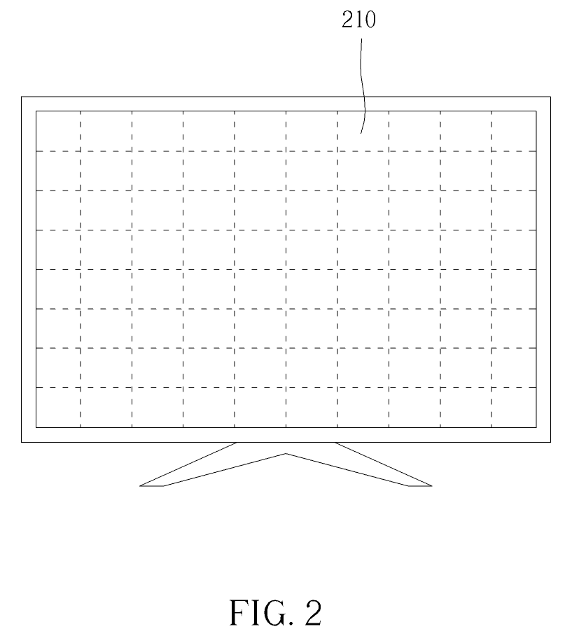

The display 100 supports an intelligent dimming function. That is, the display 100 uses the ambient light sensor 102 to detect the brightness of the surrounding ambient light and adjusts the brightness of the backlight source in the display panel 104 accordingly. For example, when the ambient light brightness is high, the processing circuit 110 can control the display panel 104 to increase the backlight brightness. Conversely, when the ambient light brightness is low, the processing circuit 110 can control the display panel 104 to reduce the backlight brightness, providing the user with better viewing comfort. As described in prior art, when the backlight brightness of the display 100 is reduced due to the very low ambient light, and the image content displayed by the display 100 itself corresponds to a very low brightness, it will cause the details of the display image to disappear or it becomes blurry and affects the viewing quality. To address this issue, in this embodiment, the image data (image frame data) is divided into multiple regions, such as the regions 210 shown in FIG. 2. The display 100 dynamically adjusts the backlight brightness of each region based on the ambient light brightness and the brightness of the image content in different regions of the display 100. In this embodiment, each region 210 has N×N pixels, where N can be any suitable positive integer. Furthermore, each region 210 corresponds to one or more backlight sources, which can be light-emitting diodes (LEDs), mini light-emitting diodes (mini-LEDs), micro light-emitting diodes (micro-LEDs), or any other suitable light-emitting elements.

Specifically, the processing circuit 110 receives image data, which includes multiple color components or color space data within an image frame, such as the values of red, green, and blue components. The statistical circuit 112 calculates the brightness characteristics of each region 210 within the image frame. These brightness characteristics of region 210 can be the average brightness of multiple pixels in the region or other values that reflect the average brightness. Subsequently, the backlight brightness calculation circuit 114 determines the backlight brightness for each region based on the ambient light brightness detected by the ambient light sensor 102 and the brightness characteristics of each region.

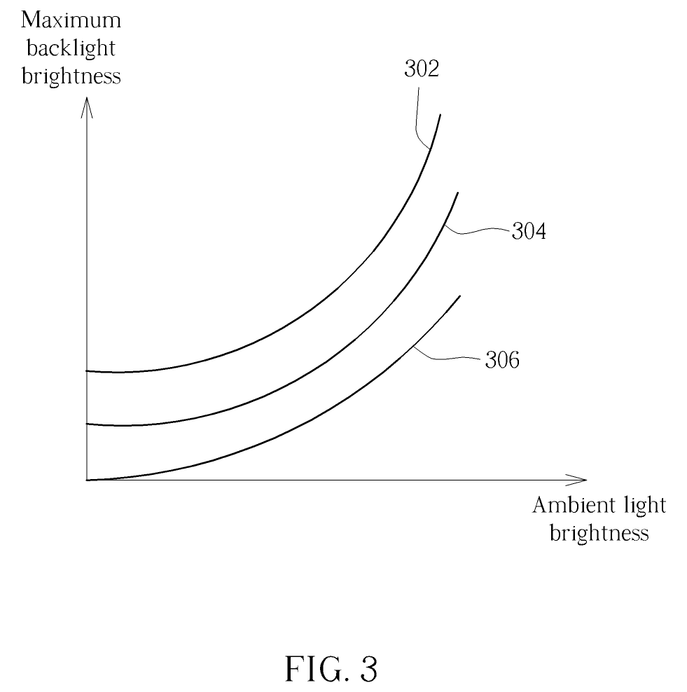

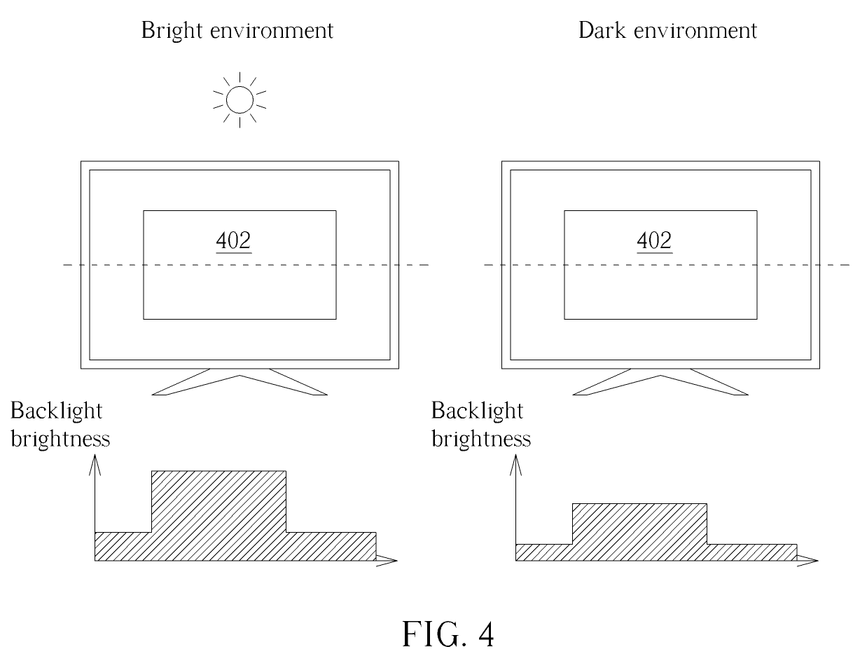

In one embodiment, if the ambient light sensor 102 detects high ambient light, such as the ambient light exceeds a first threshold value, the backlight brightness calculation circuit 114 can use an internal algorithm or a lookup table to determine the maximum backlight brightness for each region based on the ambient light brightness detected by the sensor 102. Then, this maximum backlight brightness is reduced according to the brightness characteristics of each region to determine the final backlight brightness for that region. In one embodiment, the relationship between ambient light brightness and the maximum backlight brightness of each region of the display 100 can follow the curves 302, 304 or 306 shown in FIG. 3. The maximum backlight brightness is set to ensure the user experiences optimal viewing comfort. Referring to the left side of FIG. 4, assume the image frame data includes a black background and a bright central region 402. The backlight brightness calculation circuit 114 can determine lower backlight brightness for the regions corresponding to the left and right sides, while assigning higher backlight brightness to the central region.

In one embodiment, if the ambient light sensor 102 detects low ambient light, such as the ambient light is lower than a second threshold value that is lower than the first threshold value, the backlight brightness calculation circuit 114 can first determine the maximum backlight brightness for each region using an internal algorithm or lookup table based on the ambient light brightness detected by the sensor 102. Then, this maximum brightness is reduced according to the brightness characteristics of each region to determine the final backlight brightness for that region, while maintaining a certain level of contrast. In this embodiment, the relationship between ambient light brightness and the maximum backlight brightness of each region in the display 100 can follow the curves 302, 304 or 306 shown in FIG. 3. To prevent excessive backlight reduction in low ambient light conditions, which could make regions with inherently low brightness appear blurred, the backlight brightness calculation circuit 114 limits the reduction in backlight brightness for regions with lower brightness characteristics, ensuring that the contrast remains above a predetermined value. Referring to FIG. 4, in comparison to high ambient light conditions, under low ambient light, the backlight brightness calculation circuit 114 can significantly reduce the backlight brightness for the central region while only slightly reducing the brightness for the left and right regions. This prevents the image content in the left and right regions from becoming blurred. In the embodiment shown in FIG. 4, due to the differing proportions of backlight brightness reduction between the central and side regions under low ambient light, the contrast is also reduced compared to high ambient light conditions. Thus, when adjusting backlight brightness under low ambient light, the backlight brightness calculation circuit 114 considers the need to maintain the contrast above a predetermined value to avoid excessive contrast reduction caused by the differential adjustments to backlight brightness in different regions.

In one embodiment, when the ambient light brightness indicates that the display 100 is in a bright environment, and the image data includes multiple regions with a bright region having high brightness characteristics and a dark region having low brightness characteristics, the backlight brightness calculation circuit 114 determines that the bright region and the dark region have a first backlight brightness and a second backlight brightness, respectively. When the ambient light brightness indicates that the display 100 is in a dark environment, the backlight brightness calculation circuit 114 determines that the bright region and the dark region have a third backlight brightness and a fourth backlight brightness, respectively. In this case, the reduction ratio applied to the first backlight brightness to obtain the third backlight brightness is greater than the reduction ratio applied to the second backlight brightness to obtain the fourth backlight brightness.

In the above embodiment, contrast is defined as the ratio of the white screen (maximum brightness) to the black screen (minimum brightness) when the display panel 104 displays image data. Therefore, the backlight brightness calculation circuit 114 can determine an allowable minimum backlight brightness for all calculated regions or at least a subset of regions. This ensures that adjustments to the backlight brightness in different regions do not result in an excessive reduction in contrast.

Then, the local dimming control circuit 116 generates corresponding backlight control signals based on the backlight brightness calculated by the backlight brightness calculation circuit 114 for each region. These backlight control signals are used to adjust the backlight sources in the display panel 104 corresponding to each region.

Additionally, the compensation circuit 118 compensates the image data based on the backlight brightness calculated for each region by the backlight brightness calculation circuit 114, to generate processed image data to be displayed on the display panel 104. This compensation may include color shift compensation and dynamic low-blue-light compensation. In one embodiment, the display panel 104 can implement local dimming in two ways: by controlling the current values of the backlight sources or by using pulse-width modulation (PWM) signals to adjust the duty cycle of the backlight sources. When the backlight brightness varies across different regions of the display, slight color shifts may occur in the displayed image. To address this, the compensation circuit 118 uses a predefined color shift model or a lookup table to determine the gain values required for each color component in each region under different backlight brightness and performs the necessary compensation. In another embodiment, the compensation circuit 118 can also perform low-blue-light compensation on the image data by reducing the values of the blue components in the image data, thereby decreasing the spectral energy of blue light to achieve eye protection. In this process, the blue component is typically multiplied by a gain value less than "1" to reduce its intensity. However, applying low-blue-light compensation solely to the blue component can cause the image to appear yellowish, thereby affecting viewing quality. In this embodiment, due to the operations of the backlight brightness calculation circuit 114 and the local dimming control circuit 116, the overall backlight brightness in certain regions of the image data is already reduced. As a result, the compensation circuit 118 does not need to apply excessive low-blue-light compensation, mitigating the color shift issues present in prior art. For instance, in the region 210, suppose a predefined gain value of "0.8" is initially set to reduce the blue component in the image data. If the backlight brightness calculation circuit 114 and the local dimming control circuit 116 have already reduced the backlight brightness to 90% of its original value (a factor of "0.9"), the compensation circuit 118 only needs to apply a lower gain value, such as "(0.8/0.9)," to reduce the value of the blue component. This prevents excessive adjustments to the blue component and avoids significant color shifts.

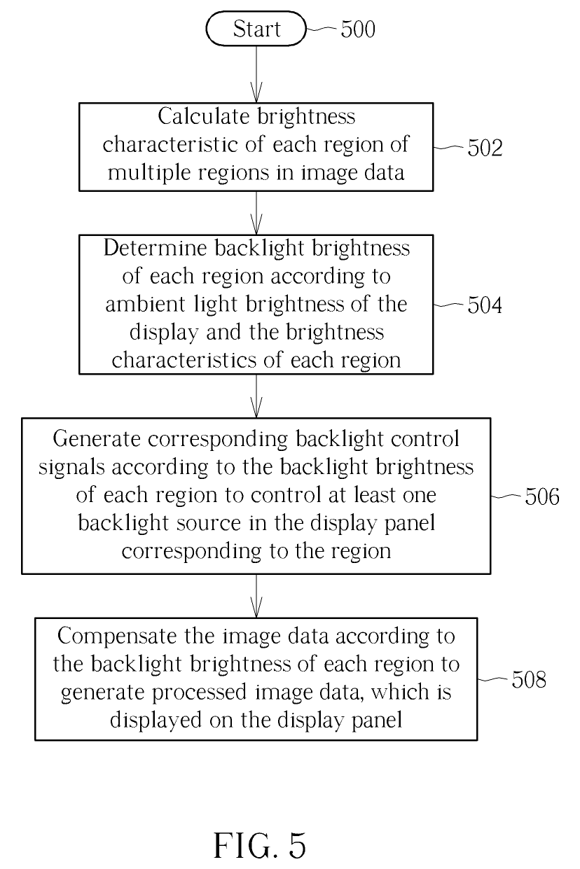

FIG. 5 is a flowchart of a control method of the display 100 according to an embodiment of the present invention. Referring to the above embodiments, the flow is described as follows:

Step 500: the flow starts.

Step 502: calculate brightness characteristic of each region of multiple regions in image data.

Step 504: determine backlight brightness of each region according to ambient light brightness of the display and the brightness characteristics of each region.

Step 506: generate corresponding backlight control signals according to the backlight brightness of each region to control at least one backlight source in the display panel corresponding to the region.

Step 508: compensate the image data according to the backlight brightness of each region to generate processed image data, which is displayed on the display panel.

In summary, in the control method of the display of the present invention, the backlight brightness of each region is dynamically adjusted according to the ambient light brightness and the brightness of image content in different regions, providing users with improved viewing comfort. Additionally, the processing circuit compensates the image data according to the adjusted backlight brightness of each region, effectively reducing color shift issues.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processing circuit of a display, comprising:
a statistical circuit, configured to calculate brightness characteristic of each region of multiple regions in image data;
a backlight brightness calculation circuit, configured to determine backlight brightness of each region according to ambient light brightness of the display and the brightness characteristics of each region; and
a local dimming control circuit, coupled to the backlight brightness calculation circuit, configured to generate a corresponding backlight control signal according to the backlight brightness of each region to control at least one backlight source in a display panel of the display corresponding to the region.

2. The processing circuit of claim 1, wherein the brightness characteristic of each region is an average brightness of the region.

3. The processing circuit of claim 1, wherein when the ambient light brightness indicates that the display is in a bright environment, and the multiple regions include a bright region with a high brightness characteristic and a dark region with a low brightness characteristic, the backlight brightness calculation circuit determines a first backlight brightness for the bright region and a second backlight brightness for the dark region; and when the ambient light brightness indicates that the display is in a dark environment, the backlight brightness calculation circuit determines a third backlight brightness for the bright region and a fourth backlight brightness for the dark region, wherein a reduction ratio applied to the first backlight brightness to obtain the third backlight brightness is greater than a reduction ratio applied to the second backlight brightness to obtain the fourth backlight brightness.

4. The processing circuit of claim 3, wherein when the ambient light brightness indicates that the display is in the dark environment, the backlight brightness calculation circuit determines the third backlight brightness for the bright region and the fourth backlight brightness for the dark region according to the ambient light brightness of the display, the high brightness characteristic of the bright region and the low brightness characteristic of the dark region, while maintaining a contrast ratio higher than a predetermined value.

5. The processing circuit of claim 1, further comprising:
a compensation circuit, coupled to the backlight brightness calculation circuit, configured to compensate the image data according to the backlight brightness calculated for each region by the backlight brightness calculation circuit, to generate processed image data for display on the display panel.

6. A control method of a display, comprising:
calculating brightness characteristic of each region of multiple regions in image data;
determining backlight brightness of each region according to ambient light brightness of the display and the brightness characteristics of each region; and
generating a corresponding backlight control signal according to the backlight brightness of each region to control at least one backlight source in a display panel of the display corresponding to the region.

7. The control method of claim 6, wherein the brightness characteristic of each region is an average brightness of the region.

8. The control method of claim 6, wherein the step of determining the backlight brightness of each region according to the ambient light brightness of the display and the brightness characteristics of each region comprises:
when the ambient light brightness indicates that the display is in a bright environment, and the multiple regions include a bright region with a high brightness characteristic and a dark region with a low brightness characteristic, determining a first backlight brightness for the bright region and a second backlight brightness for the dark region; and
when the ambient light brightness indicates that the display is in a dark environment, determining a third backlight brightness for the bright region and a fourth backlight brightness for the dark region, wherein a reduction ratio applied to the first backlight brightness to obtain the third backlight brightness is greater than a reduction ratio applied to the second backlight brightness to obtain the fourth backlight brightness.

9. The control method of claim 8, wherein the step of determining the backlight brightness of each region according to the ambient light brightness of the display and the brightness characteristics of each region comprises:
when the ambient light brightness indicates that the display is in the dark environment, determining the third backlight brightness for the bright region and the fourth backlight brightness for the dark region according to the ambient light brightness of the display, the high brightness characteristic of the bright region and the low brightness characteristic of the dark region, while maintaining a contrast ratio higher than a predetermined value.

10. The control method of claim 6, further comprising:
compensating the image data according to the backlight brightness of each region, to generate processed image data for display on the display panel.
